(19) United States
(12) Patent Application Publication
(10) Pub. No.: US 2005/0047166 A1
(43) Pub. Date: Mar. 3, 2005

(54) Exterior projector lens lamp

(76) Inventors: Dirk-Martin Skirha, Seymour, IN (US); David DeWayne Egly, Columbus, IN (US); Sanders R. Brott, Seymour, IN (US); Robert L. King, Seymour, IN (US)

Correspondence Address: William E. Meyer;OSRAM SYLVANIA Inc., 100 Endicott Street, Danvers, MA, 01923, US

(21) Appl. No.: 10/920,927

(22) Filed: Aug. 18, 2004

Related U.S. Application Data
(60) Provisional application No. 60/498,246, filed on Aug. 27, 2003.

(51) Int. Cl. B60Q 1/00

(52) U.S. Cl. 362/538

(57) ABSTRACT

A projection lamp (10) suitable for an automotive headlight has a housing (12) with an hermetically sealed light source (14) positioned at one end (16) and a lens (18) positioned at another opposite end (20). The lens (18) includes a peripheral flange (22) that engages a flange (24) on end (20) of housing (14). A bezel (26) is positioned at the end (20) of the housing (14) and is attached thereto. The bezel (26) includes a lens receiving opening (28) therein and an environmental sealing gasket (30) is positioned, under compression, between an outer peripheral location (32) on the lens (18) and an internal flange (34) surrounding the lens receiving opening (28) in the bezel (26).

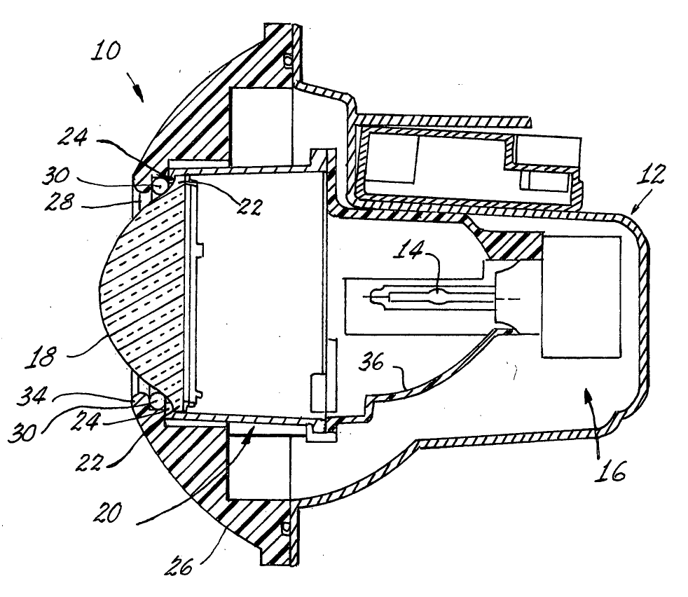

### CROSS-REFERENCE TO RELATED APPLICATION

This application claims priority from Provisional Patent Application No. 60/498,246, filed Aug. 27, 2003.

### TECHNICAL FIELD

This invention relates to lamps and more particularly to automotive headlamps. Still more particularly it relates to an automotive headlamp employing a projection lens.

### BACKGROUND ART

Projection lens headlamps have recently been used in automotive applications. Such lamps involve a first projection lens attached to a housing and a second lens formed as a part of the automobile, usually as a part of a fender. A considerable airspace is provided between the two lenses resulting in an increased length of an overall assembly, a length that causes considerable design problems for the automotive industry, as well as extra expense.

### DISCLOSURE OF INVENTION

It is, therefore, an object of the invention to obviate the disadvantages of the prior art.

It is another object of the invention to enhance projection automotive headlamps.

Another object of the invention is the decrease in the length necessary for utilization of projection headlamps.

These objects are accomplished, in one aspect of the invention, by a lamp comprising a housing with an hermetically sealed light source positioned at one end. A lens is positioned at an opposite end of the housing and the lens includes a peripheral flange that engages a flange that is formed on the opposite end of the housing. A bezel is positioned at the end of the housing opposite the light source and is attached thereto. The bezel includes a lens receiving opening therein. An environmental sealing gasket is positioned between an outer peripheral location on the lens and an internal flange surrounding the lens-receiving opening in the bezel.

This construction eliminates the need for the second lens and greatly reduces the length dimension necessary for mounting the lamp.

### BRIEF DESCRIPTION OF THE DRAWINGS

The single figure is an elevational sectional view of an embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawing with greater particularity, there is shown in the figure a lamp 10 suitable for an automotive headlight. The lamp 10 has a housing 12 of a suitable material such as plastic. An hermetically sealed light source 14, for example, a high intensity arc discharge tube, is positioned at one end 16 of the housing 12 and a lens 18 is positioned at another end 20 of the housing, opposite the end 16. The lens 18 is a plano-convex lens and includes a peripheral flange 22 for engaging a flange 24 on the end 20 of housing 12. The lens material is preferably a hard plastic or glass. Since DOT and SAE regulations require lens markings to be on the outside on the visible lens surface, appropriate techniques for applying the necessary markings can include laser etched diode pumping, masking and blasting with an aggressive media or carbide pen etching.

A bezel 26 is fitted to the end 20 of the housing 12 and is attached thereto in any suitable manner. The bezel 26 includes a lens receiving opening 28 therein.

A sealing gasket 30 of a suitable material such as Teflon, silicon or urethane is positioned between an outer peripheral location 32 on the lens 18 and an internal flange 34 surrounding the lens receiving opening 28 in the bezel 26. A reflector 36 can be operatively positioned about the light source 14.

The housing 12 can also be provided with areas to mount the necessary electronics in the form of a ballast, if the light source is an arc discharge source.

The gasket 30 is of a size to be compressed at least slightly after installation, thereby providing an environmental seal for the lamp and eliminating the need for a secondary lens or lens covering.

The elimination of the secondary lens also shortens the overall length of the lamp assembly, restoring much needed space to designers.

While there have been shown and described what are present considered to be the preferred embodiments of the invention, it will be apparent to those skilled in the art that various changes and modifications can be made herein without departing from the scope of the invention as defined by the appended claims.

1. A lamp comprising:
a housing;
an hermetically sealed light source positioned at one end of said housing:
a lens positioned at another end of said housing said lens including a peripheral flange engaging a flange on said another end of said housing;
a bezel at said another end of said housing and attached thereto, said bezel including a lens receiving opening therein; and
an environmental sealing gasket positioned between an outer peripheral location on said lens and an internal flange surrounding said lens receiving opening in said bezel.

2. The lamp of claim 1 wherein said hermetically sealed light source in a high intensity discharge arc tube.

3. The lamp of claim 1 wherein said lens is a plano-convex lens.

4. The lamp of claim 1 wherein said lamp is an automotive headlamp.

5. The lamp of claim 1 wherein said hermetically sealed light source has a parabolic reflector operatively positioned thereabout.
